(19) United States
(12) Patent Application Publication
(10) Pub. No.: US 2026/0032223 A1
(43) Pub. Date: Jan. 29, 2026

(54) PROJECTION DEVICE AND METHOD FOR PROCESSING PARTITION BACKLIGHTING OF PROJECTED IMAGE

(71) Applicant: MediaTek Singapore Pte. Ltd., Singapore (SG)

(72) Inventor: Weijia WANG, Shenzhen (CN)

(21) Appl. No.: 19/248,599

(22) Filed: Jun. 25, 2025

(30) Foreign Application Priority Data
Jul. 23, 2024 (CN) 202410994569.8

(51) Int. Cl. H04N 9/31

(52) U.S. Cl. CPC H04N 9/3185; H04N 9/3182

(57) ABSTRACT

The present invention provides a projection device and method for processing partition backlighting of a projected image. The method is executed by the projection device, which projects an original image onto a projection screen to display the projected image. The method includes performing the keystone correction on the original image to be projected to obtain corrected image data and correcting the backlighting brightness of at least one of a plurality of backlighting partitions of the projection device, respectively based on the corrected image data after the keystone correction. The method further includes performing the backlighting smoothing processing on the edge portion of the at least one backlighting partition. The method further includes performing the backlighting smoothing processing on an edge of the projected image and the backlighting of the junction partition adjacent to the backlighting image.

### CROSS REFERENCE TO RELATED APPLICATIONS

This Application claims priority of China Patent Application No. 202410994569.8, filed on Jul. 23, 2024, the entirety of which is incorporated by reference herein.

### BACKGROUND OF THE INVENTION

### Field of the Invention

The present invention relates to backlighting source processing technology for projection, and relates to, but is not limited to, LED projection, laser projection, and other projection methods and related devices having a backlighting source.

### Description of the Related Art

The traditional backlighting used in projection applications is overall backlighting. Namely, the backlighting of all areas in the projection screen is set to the same type and mode (e.g., set to the same backlighting brightness value, color calibration and contrast). However, overall backlighting has the following shortcomings. For example, (1) there is insufficient local contrast: when the overall backlighting displays an image, since there is only one backlighting source for the entire screen, the problem of insufficient contrast may occur when displaying dark and bright areas, which affects the detailed performance of the image. It has (2) poor black performance: due to the limitations of overall backlighting, the display may appear gray or dark when displaying the color black, which affects the black performance. There is (3) uneven local brightness and darkness: when displaying dark images, the overall backlighting may have uneven local brightness and darkness, namely, phenomena such as “bright edge” or “light leakage” may occur, which affects the uniformity of the image. It exhibits (4) higher energy consumption: the overall backlighting needs to be lit up as a whole when displaying bright-color images, so it consumes more energy when displaying bright-color images. There is (5) limited local dimming: the local dimming ability of the overall backlighting is limited, and it is difficult to carry out fine dimming for each area, which affects the dynamic contrast of the displayed image. For these reasons, it is clear that there is a need for a new type of backlighting solution for projection equipment applications.

### BRIEF SUMMARY OF THE INVENTION

A projection device and method for processing partition backlighting of a projected image is provided. The method is executed by a projection device, which projects an original image onto a projection screen to display the projected image. The method comprises performing keystone correction on the original image to be projected to obtain corrected image data and correcting the backlighting brightness of at least one of a plurality of backlighting partitions of the projection device respectively based on the corrected image data after the keystone correction. The method further comprises performing the backlighting smoothing processing on the edge portion of the at least one backlighting partition. The method further comprises performing the backlighting smoothing processing on an edge of the projected image and the backlighting of the junction partition adjacent to the backlighting image. In some embodiments of the present invention, the device and method for processing backlighting can improve the contrast of the projected image and maintain the level of performance of the system.

### BRIEF DESCRIPTION OF THE DRAWINGS

The present invention can be more fully understood by reading the subsequent detailed description and examples with references made to the accompanying drawings, wherein:

FIG. 1 illustrates an example of the design according to the present invention, where the backlighting of the projection screen is processed using partition backlighting, backlighting partitions and arrangement.

FIG. 2 illustrates an example of an original image to be projected.

FIG. 3 illustrates an image that is similar in scale to the original image when the projection is projected forward onto a wall.

FIG. 4 illustrates the position and shape of the displayed image when it is projected on the projection screen without keystone correction.

FIG. 5 illustrates the relative position of the data and the backlighting after keystone correction of the projected image in accordance with an embodiment of the present invention.

FIG. 6 illustrates the relative position and shape of the image data, as well as the backlighting display on the screen, after the projection device has performed keystone correction.

FIG. 7 illustrates a flowchart of the method for partition backlighting correction after the correction of the projected image in accordance with an embodiment of the present invention.

FIG. 8 illustrates a flowchart of the backlight jaggedness removal treatment of an image and backlighting junction region after keystone correction in accordance with another embodiment of the present invention.

FIG. 9 is a schematic illustration of the principle of calculating the corrected image and partition position after keystone correction.

FIG. 10 illustrates a flowchart of the method for partition backlighting smoothing adjacent to the projected image in accordance with another embodiment of the present invention.

FIG. 11 illustrates a block diagram of the projection device in accordance with an embodiment of the present invention.

### DETAILED DESCRIPTION OF THE INVENTION

The following description is made for the purpose of illustrating the above objects, features and advantages of some embodiments of the present invention more readily understandable, clearly and completely in conjunction with the accompanying drawings.

Certain terms are used throughout the description and the following claims to refer to particular components. As will be appreciated by those skilled in the art, manufacturers of electronic devices may use different names to refer to the same component. It is not the intent of the invention to differentiate between components that have different names but perform the same function. It should be understood that the words “comprises,” “includes,” and “has” are used in an open-ended manner and should be interpreted to mean “includes, but is not limited to . . . ”. Therefore, when the terms “comprising”, “including” and/or “having” are used in the present invention to indicate the presence of specific technical features, values, method steps, operations, units and/or components, it does not preclude the possibility of adding the following terms: “including”, “comprising” and/or “having”.

Orientation terms used throughout the description and the following claims (e.g., “up”, “down”, “front”, “back”, “left”, “right”, etc.,) refer only to the orientation of the accompanying drawings. Thus, the orientation terms are used to explain and not to limit the present invention. With respect to the accompanying drawings, the accompanying drawings show general features of methods, structures, and/or materials used in particular embodiments. However, the accompanying drawings should not be interpreted as defining or limiting the scope or properties covered by these embodiments. For example, the relative size, thickness, and location of each layer, each region, and/or each structure may be reduced or enlarged for clarity.

When a corresponding component, such as a layer or area, is referred to be “on another component”, it may be directly on that component, or there may be other components between them. On the other hand, when a component is referred to as being “directly on another component (or a variant thereof)”, there are no other components between them. Furthermore, when a corresponding component is referred to as “on the other component”, the corresponding component and the other component have a top view/vertical arrangement relationship. The corresponding component may be below or above the other component, and the top view/vertical arrangement relationship is determined by the orientation of a device.

It should be understood that when a component or layer is referred to be “connected” to another component or layer, it may be directly connected to that component or layer, or there may be intermediate components or layers. Conversely, when a component is referred to be “directly connected” to another component or layer, there is no intermediate component or layer between them.

The electrical connection or coupling described in this invention may refer to a direct connection or an indirect connection. In a case of the direct connection, the endpoints of components on two circuits are directly connected or connected by wire segments, while in a case of the indirect connection, a switch, diode, capacitor, inductor, resistor, other suitable components, or a combination of the foregoing components is present between the endpoints of components on two circuits, but the intermediate components are not limited here.

If the backlighting is divided horizontally and vertically into different partitions of the backlighting source, the backlighting of each partition is determined based on the current data content that corresponds to the partition, such that a higher contrast ratio and an energy-saving effect can be achieved. Wherein the partitioning of the backlighting device of the projection screen is not limited to dividing horizontally and vertically, it is understood that any partitioning method that sets the backlighting of the projection screen into a plurality of partitions is within the scope of protection of the present invention. In the present invention, the manner of dividing the backlighting of the projection screen into a plurality of partitions and setting them separately is referred to as local backlighting, local dimming, partition backlighting, or partition dimming.

Partition backlighting is a liquid crystal display technology. Compared with the overall backlighting, it has the following advantages: (1) Contrast enhancement: partition backlighting can dynamically adjust the backlighting brightness according to the content of different areas of the image, so that the darker part is darker and the brighter part is brighter, thus the contrast of the displayed image can be enhanced. (2) Black performance improvement: partition backlighting technology can carry out fine dimming of the dark part to improve the black performance effect and reduce grayness or darkening. (3) Power consumption reduction: local backlighting can adjust the brightness of the backlighting according to the image content, so it can reduce the brightness of the backlighting when displaying dark images, thus the power consumption reduction can be achieved. (4) Uniformity improvement: local backlighting technology can reduce the “bright edge” or “light leakage” phenomenon, which improves the uniformity of the displayed image. (5) Dynamic contrast enhancement: local backlighting technology can carry out fine dimming of each area to enhance the dynamic contrast of the displayed image to make the image more vivid and realistic. However, when a projection device uses local backlighting, there are various problems that can be encountered. For example, because the projected image needs to be keystone corrected, the image after keystone correction will be changed in shape and angle, which results in that the image data will not match the rectangular backlighting of the projection screen. Hence, it is necessary to solve the problem of the mismatch between the image data after keystone correction of the projected image and the data of the backlighting partition. Further, the edges of the projected image after keystone correction will have backlight jaggedness because the backlighting is partitioned, so it is necessary to do the backlight jaggedness removal treatment. Furthermore, because the backlighting source of the projection screen is a light beam projected forward, the energy is concentrated in a certain range. Additionally, each backlighting partition is elliptical and the brightness at the edges decreases more rapidly. As a result, the transition between the brightness of the different partitions is not smooth enough, and therefore, the smoothing processing needs to be applied to the backlighting partitions.

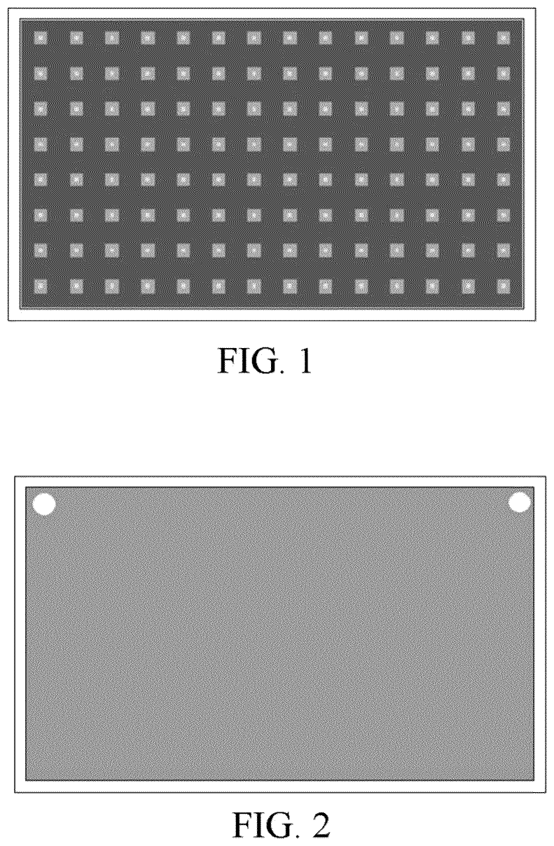

FIG. 1 is an example of a design according to the present invention that enables the backlighting of the projection screen to be processed by the partition backlighting, the backlighting partition and arrangement. The exact number of divided horizontal and vertical regions can be determined according to the design requirements. For example, it is determined according to the area of the backlighting panel and the size of the driver integrated chip (IC) and the backlighting module. For example, the LED projection shown in FIG. 1, the backlighting is in a 14×8 arrangement with 14 horizontal columns and 8 vertical rows for a total of 112 backlights. In the practical case, the size of each light is about 5 mm×4 mm, and the spacing between lights is about 6 mm. If it is an LED projection, which is limited by the area of the projection backlight board, generally it cannot have too many backlights; typically around 100 LED lights. Because of the wiring, it is difficult to significantly reduce the space between the LED lights.

FIG. 2 is an illustrative example of the original image to be projected. The projection shows two small circular suns in the upper left and the upper right corners of the image.

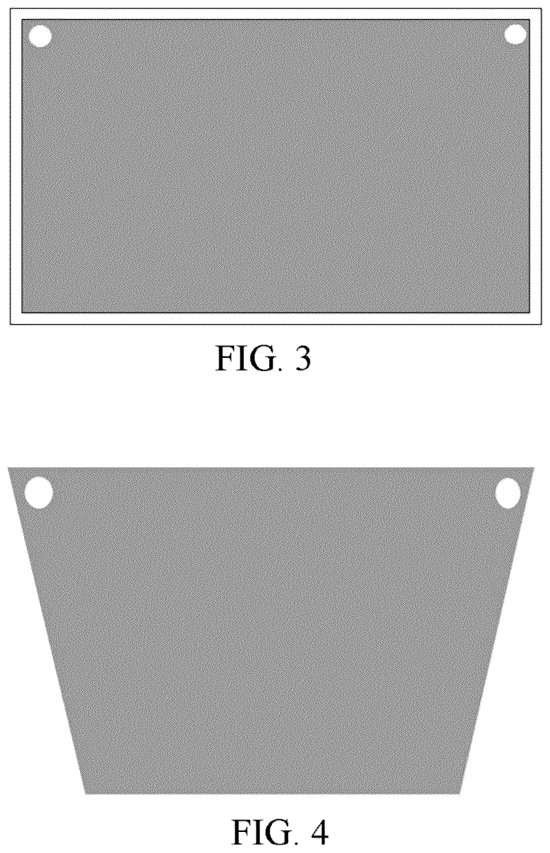

FIG. 3 is an illustration of a rectangular image that is similar in scale to the original image display if the projection is projected forward onto a wall.

FIG. 4 is an example of the displayed image when the original image is projected on the projection screen without keystone correction. In order to illustrate the practical use in the real situation, the projection usually needs to be placed on the table to project upward onto a wall. The image will appear as follows: a wide upper part and narrow lower part, if there is no keystone correction. Alternatively, the projection hanging from the ceiling projects downward onto a wall. The image will appear as follows: a narrow upper and wide lower part, if there is no keystone correction.

Next, an example will be the case where the projection is placed on the table and projected upward onto a wall in the following description to illustrate the problems of the keystone correction processing and the solution method herein. However, the scope of the present invention is not limited to processing and correcting the wide upper and narrow lower projection image shown in the accompanying drawings, but it shall process all shapes of projection images as well as backlighting settings as understood by those skilled in the art.

For daily use of the projector, it should be positioned at right angle to the projection screen as much as possible in order to ensure the projection effect. If it is not guaranteed to ensure the perpendicularity of both the projector and the projection screen, the image will become a trapezoid. In this case, user needs to use the “Keystone Correction Function” to correct the trapezoid to ensure that the image is a standard rectangle. Hence, the trapezoidal distortion of the image due to upward projection or ceiling projection can be corrected.

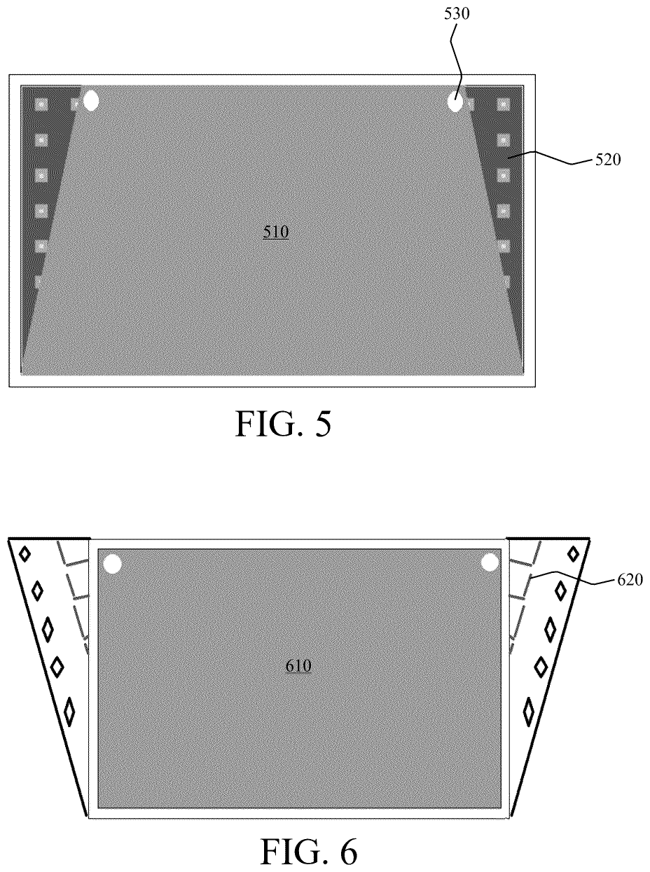

FIG. 5 is an illustration of an example of a projected image in accordance with an embodiment of the present invention. In FIG. 5, if the keystone correction is used to make the image on the wall as rectangular shown in FIG. 3, then after the projection device performs the keystone correction on the original image, it will be as the light grey region 510 shown in FIG. 5. The light grey region 510 is the image's full-screen display region. At this time, the all-white regions 530 in the upper-left and upper-right corners are moved inwardly and narrowed proportionately after the extraction of the columns. Also at this time, the two small circular regions are not in the upper-left and upper-right corners of the corresponding backlighting regions of the original image before keystone correction. It results in a position mismatch between the projected image region and its corresponding backlighting region.

In order to solve the problem of the position mismatch between the projected image region and the backlighting region, an embodiment of the present invention provides a technique for the re-mapping of the image data processing and the backlighting setting after keystone correction of the projected image.

The present invention provides a backlighting processing method for the projection image to process the backlighting data at the corresponding position and calculate the brightness of the corresponding backlighting region according to the image data after keystone correction. The position of the backlighting region of the projection screen is unchanged, and the partition regions are still the same. The brightness of the corresponding backlighting region is calculated according to the image data after keystone correction. The average brightness and maximum brightness of each backlighting region, which is processed by the spatial filter algorithm, the peaking algorithm, and other algorithms, are calculated to enhance the contrast and obtain the final brightness of each backlighting region. The final effect is that there is no brightness or lower brightness of the backlighting region (related to the actual region data content) in the triangular regions on both sides of FIG. 5. However, the traditional projection method in this case is that the triangular regions on both sides of FIG. 5 are also backlit, which affects the perception.

FIG. 6 is an example of an image projected on the projection screen after the projection device performs keystone correction. When the projection device performs the keystone correction, the corrected image shown in the light grey part 510 of FIG. 5 and the backlighting regions (including the dark grey regions 520 covered by the light grey part 510) shown in the dark grey part 520 of FIG. 5 will be obtained. If the brightness of the backlighting of the projection device is not adjusted accordingly to the keystone correction of the image, then after the image is projected onto the projection screen, the backlighting regions that do not match the data in the triangular regions on both sides in FIG. 5 will be correspondingly projected onto the triangular regions on the left and right sides in FIG. 6. The backlighting sources that correspond to the triangular regions on the left and right sides in FIG. 6 are not covered by the corrected image shown in the light grey part 510 of FIG. 5, namely, there is no corresponding corrected image data, so it is expected that these backlighting sources are not illuminated. Therefore, the backlighting correction method of the projection device provided in the present invention can solve this problem.

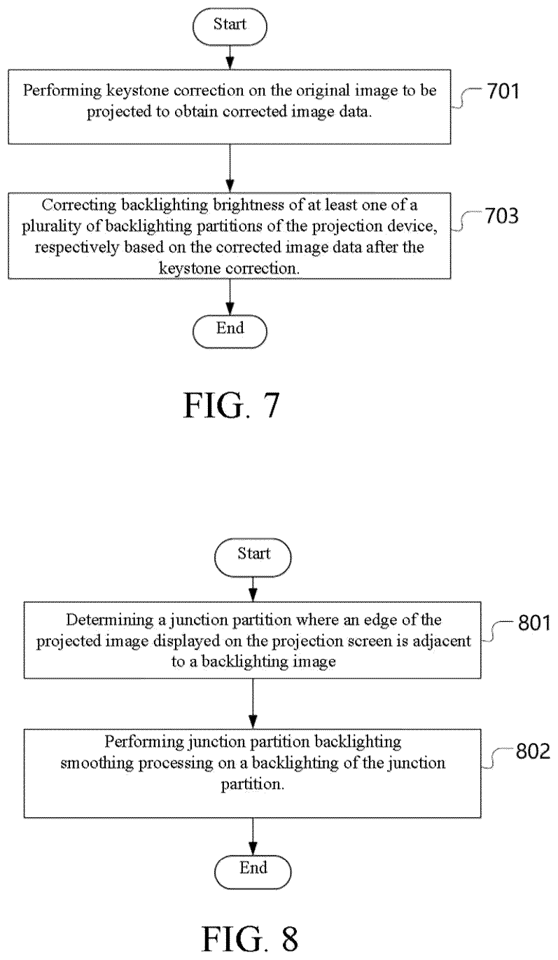

Referring to FIG. 7, it is a flowchart of the method for backlighting correction of a projection image partition in accordance with embodiment of the present invention. In step 701, the projection device performs the keystone correction for an original image to be projected to obtain corrected image data. In step 703, the projection device respectively corrects the backlighting brightness of one or more backlighting partitions based on the corrected image data after the keystone correction. The projection device corrects the backlighting brightness of the backlighting partition at a corresponding position based on the corrected image data of at least one of the backlighting partitions in the same position. Wherein the position of at least one backlighting partition is any of the overall backlighting regions of the projection device. The corrected image has a plurality of image partitions, and at least one of the backlighting partitions which correspond to at least one of the image partitions of the corrected image. The position coordinates of at least one of the backlighting partitions are the same as the position coordinates of at least one of the image partitions of the corrected image. For example, the original backlighting value set by the backlighting partitions of the projection device corresponds to the brightness of the image data of a plurality of partitions of the original image to be projected in the same position. After the projection device performs the keystone correction for the original image to be projected, the corrected image will be obtained and the position of each partition will be changed. The projection device adjusts the brightness of a plurality of partitions of the backlighting region according to the change in the position of the partitioned image of the corrected image after the keystone correction. For example, the brightness of the first backlighting source (e.g., the backlighting source at the upper left corner of the overall backlighting region) located at the first position in the first backlighting region corresponds to the image data at a corresponding position (e.g., the circular region at the upper left corner of the original image) of the original image to be projected before the projection device performs the keystone correction. The brightness of the first backlighting source located at the first position in the first backlighting region will be corrected according to the brightness value which corresponds to the image data at the first position of the corrected image after the projection device performs the keystone correction.

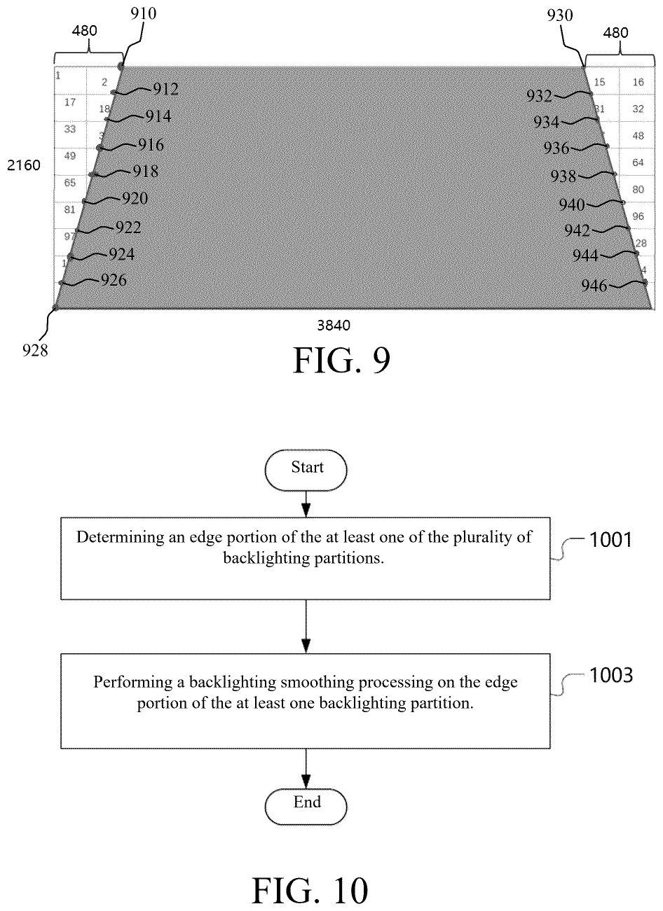

Due to the brightness of the corrected image, which junctions with the surrounding black backlighting brightness region, the areas marked by the folded lines 620 in FIG. 6 may exhibit the jaggedness due to the difference in brightness intensity. In order to solve the backlighting jaggedness problem, another embodiment of the present invention provides a backlighting jaggedness removal technique for correcting the edge of an image after the projection device performs the keystone correction. Referring to FIG. 8, it is a flowchart of the method for the backlighting correction of the projected image partition according to another embodiment of the present invention. In step 801, the junction partition where the edge of the projected image displayed on the projection screen is adjacent to the backlighting image is determined. As shown in FIG. 6, the junction region between the light grey part 610 of the projected image displayed on the projection screen when the corrected image is projected and the black wide upper and narrow lower backlighting image projected on the projection screen by the backlighting region of the projection device is the junction partition indicated by the red curve after the keystone correction. The junction partition may also be determined based on the backlighting regions adjacent to the edges of the corrected image. The projection device in the embodiment of the present invention calculates the position of the junction partition based on the data position of the corrected image and the information of the backlighting partition (e.g., the way of dividing the backlighting regions of X by Y). In step 803, the projection device performs the smoothing processing for the backlighting of the junction partition. Based on the actual partition information (e.g., X by Y of the actual partition) and the data position information after the keystone correction to perceive which backlighting regions are on the boundaries of the effective screen. As shown in FIG. 9, for example, the partition is 16×9, 4K 3840×2160 data. After the keystone correction, the coordinates of two corners of the upper edges of the trapezoid are positioned at x=480, y=0 and x=3460, y=0. With this information, the calculation is executed to get which backlighting regions are on the boundaries of the effective screen. As in FIG. 9, the position of each dot (910-946) may be calculated proportionally to perceive which backlighting partitions are on the boundaries that need to be recorded. In addition to the processing of FIG. 8 that needs to be used, the later steps of FIG. 10 also need to be used. Originally, it is possible that the brightness of these regions differ greatly, which causes jaggedness in the backlighting of the boundary regions. To solve this problem, our design is to execute the smoothing algorithm on the backlighting data to re-determine the appropriate new backlighting value. Here the median filter calculation method is used to achieve the purpose of smoothing the backlighting value of the boundary regions. The partition numbers and backlighting values of the boundary regions are placed in a two-dimensional array according to the top-to-bottom order. For example, the left part of FIG. 9 as follows: {{2, n2}, {18, n18}, {34, n34}, {50, n50}, {66, n66}, {65, n65}, . . . }. Wherein 2, 18, 34, . . . are partition numbers of the boundary regions, and n2, n18, n34, . . . are 16 bit backlighting values of the corresponding partition. Next, the median filter is used to get the median values from itself and the three backlighting values on the left and right, in order to recalculate and obtain the backlighting value of each boundary region, such as: the backlighting value that corresponds to the partition 2 becomes (n2+n18+n34+n50)/4; the backlighting value that corresponds to the partition 18 becomes (n2+n18+n34+n50+n66)/5; the backlighting value that corresponds to the partition 34 becomes (n2+n18+n34+n50+n66+n65)/6. By analogy, the original backlighting regions are replaced by the backlighting values of the new obtained boundary partition to smooth the backlighting partition transition and eliminate the backlighting jaggedness.

Of course, smoothing the regional backlighting value is an idea, but it is not limited to the median filter (an algorithm for data smoothing processing).

In addition, it is also necessary to record which regions are boundary partitions in this step (i.e., the partitions 2, 18, 34, . . . obtained after the above calculation) to make these boundary partitions not affected by other backlighting smoothing processing (e.g., the backlighting smoothing processing shown in FIG. 10). These boundary partitions still maintain the backlighting luminance values after the median filter processing, and the partitions on both sides of FIG. 9 that do not have backlighting luminance data (0 data) need to be recorded. Take FIG. 9 as an example, the backlighting partitions 1, 17, 33, 49, . . . , obtained after the calculation, correspond to the luminance values of 0. Namely, they originally had no backlighting. The further reversion processing of these partitions still needs to be executed after the processing of FIG. 10 to maintain the backlighting-free setting for these backlighting partitions.

The partition backlighting correction methods for the projected image shown in FIG. 8 and FIG. 7 may be used together or separately.

In addition, due to the projection backlighting, which is projected forward, the energy is concentrated in a certain range, the backlighting of each backlighting partition is an ellipse, and the brightness at the edges decreases more rapidly. As a result, the transition between the brightness of the different backlighting partitions is not smooth enough. In order to solve this problem, another embodiment of the present invention provides a method for smoothing the backlighting partition. Referring to FIG. 10, it is a flowchart of a method for the backlighting correction of the projected image according to another embodiment of the present invention. In step 1001, the data of at least backlighting partition is determined. In step 1003, the backlighting smoothing is applied to the data of at least one backlighting partition. The backlighting smoothing can be performed using the software-implemented low pass filter algorithm, wherein the parameters of the convolution kernel of the software-implemented low pass filter are adjustable. The filter is designed according to the determined low pass filter parameters to carry out the digital filter of the low pass filter, and the designed filter is applied to smooth the partition backlighting. The partition backlighting luminance values is processed by the low pass filter to smooth the backlighting changes of neighboring partitions. The new backlighting data is written into the backlighting brightness data of the partition after the low pass filter was performed.

Also of note here is that as mentioned earlier in the steps of FIG. 6 and FIG. 9, which regions that are boundary partitions are recorded. Take FIG. 9 as an example, the partitions 2, 18, 34, . . . , are obtained after the calculation. After the smoothing processing with the low pass filter, the backlighting settings from the previous median filter processing will be retained. In addition, the partitions without backlighting luminance data (0 data) on both sides of FIGS. 6 and 9 are recorded. Take FIG. 9 as an example, the backlighting partitions 1, 17, 33, 49, . . . after the calculation, the luminance data which corresponds to the backlighting of these partitions is 0. Namely, they originally had no backlighting. After the smoothing processing with the low pass filter, these backlighting partitions will revert and retain the previous settings, which had no backlighting.

The method for processing the backlighting data of the projection image shown in FIG. 10 smooths the backlighting transition between partitions, and there are parameters for adjusting the intensity of the smoothing. The processed backlighting data may be written back to adjust the data of the corrected image accordingly, enabling matching with the backlighting data. The low pass filter is an idea, and the smoothing processing of the regional backlighting data in this invention is not limited to a single type of low pass filter algorithm.

The partition backlighting correction methods for the projected image shown in FIG. 10 and FIGS. 8 and 9 may be used together or separately.

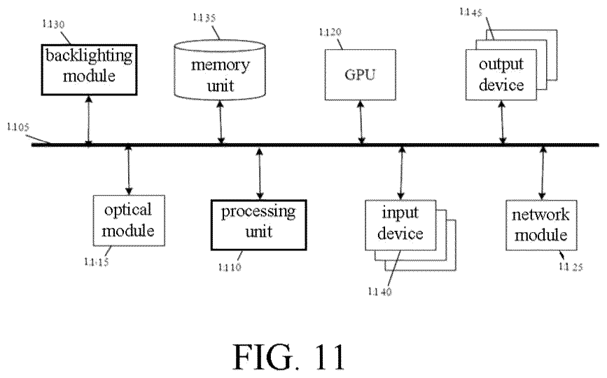

FIG. 11 is a block diagram of the projection device according to an embodiment of the present invention. The projection device comprises a processing unit 1110, a memory unit 1135, a backlighting module 1130, an optical module 1115, an input device 1140, an output device 1145, a network module 1125, a GPU 1120, and a bus 1105. The processing unit including an optical engine, an image processing engine, a display engine and the like is the core component of the projection device and it is used to process the input signals and generate the projected image. For example, the code stored in the memory is executed by the processing unit to perform the keystone correction and the partition backlighting processing shown in FIGS. 7, 8, and 10. The backlighting module is controlled to correct the backlighting brightness of one or more backlighting partitions of the projection device respectively. The backlighting module comprises a plurality of backlighting sources that are divided into a plurality of backlighting partitions in accordance with the division information. The backlighting brightness of the backlighting partitions can be adjusted separately. Therefore, not all of the backlighting partitions are set to a uniform brightness. The light source in the backlighting module that usually includes a projection bulb or LED light source, which is used to generate light of a sufficient intensity required for projection. The optical module, which includes optical elements such as a lens, a mirror, a color wheel, and the like, is used to regulate and control the propagation and the imaging of the projected light to ensure the clarity and brightness of the projected image. The keystone correction is performed on an on-screen display (OSD) and processed by the partition backlighting source.

Bus 1105 collectively represents all of the system, peripheral, and chipset bus, which communicatively connect the numerous internal devices of the projection device. For example, the bus 1105 communicatively connects the processing unit 1110, the memory unit 1135, the backlight module 1130, the optical module 1115, the input device 1140, the output device 1145, the network module 1125, and the GPU 1120.

The instructions and data are retrieved from the memory unit 1135 and the processing unit 1110 to be executed and processed for performing the processing of the present invention. In various embodiments, the processing unit may be a single processing unit or a multi-core processing unit. Some instructions are passed to the GPU 1120 and executed by it. The GPU 1120 may perform various calculations or supplement the image processing provided by the processing unit 1110.

The memory unit 1135 stores static data and instructions used by the processing unit 1110 and other modules of the electronic system. The memory unit is a non-volatile memory unit that stores instructions and data even when the projection device is turned off. Some embodiments of the present invention use a mass storage device (e.g., a disk or optical disk and its corresponding disk drive) as the memory unit 1135. Other embodiments use a removable storage device (e.g., a floppy disk, a flash memory device, etc. and its corresponding disk drive) as the memory unit. The memory unit 1135 additionally includes volatile read/write memory such as random access memory. Volatile read/write memory stores some of the instructions and data used by the processing unit at runtime. The instructions and data are retrieved from the memory unit and the processing unit 1110 to be executed and processed for performing the processing of some embodiments.

Bus 1105 is also connected to the input device 1140 and the output device 1145. The input device 1140 enables a user to transmit information and select commands to the electronic system. The input device 1140 includes alphanumeric keyboard and pointing device (also referred to as “cursor control device”), camera (e.g., webcam), microphone, or the similar devices for receiving voice commands and the like. The output device 1145 displays images generated by the projection device or otherwise outputs data. Finally, as shown in FIG. 11, the bus 1105 also couples the projection device to the network module 1125 by a network adapter (not shown). In this way, a computer may be part of a network of computers, such as a local area network (LAN), a wide area network (WAN) or internal network, or a network of networks.

Some embodiments include electronic components, such as microprocessor unit, memory, and storage, which store the computer program instructions in a machine-readable or computer-readable medium (alternatively referred to as a computer-readable storage medium, machine-readable medium, or machine-readable storage medium). Some examples of such computer-readable media include RAM, ROM, read-only disk (CD-ROM), recordable disk (CD-R), rewritable disk (CD-RW), read-only digital versatile disks (e.g., DVD-ROM, dual-layer DVD-ROM), various recordable/rewritable DVDs (e.g., DVD-RAM, DVD-RW, DVD+RW, etc.), flash memory (e.g., SD card, mini-SD card, micro-SD card, etc.), magnetic and/or solid-state hard drives, read-only and recordable Blu-Ray® disks, ultra-dense optical disk, any other optical or magnetic media, and floppy disks. The computer-readable medium may store a computer program which includes an instruction set for performing various operations executed by at least one processing unit. Examples of computer program or computer code include machine code, such as machine code generated by the compiled program, and files that include high-level code executed by a computer, an electronic component, or a microprocessor unit using an interpreter.

Although the above discussion is primarily concerned with microprocessor unit or multi-core processing unit that executes the software, many of the functions and applications described above are executed by one or more integrated circuits, such as a Specialized Application Integrated Circuit (ASIC) or a Field Programmable Gate Array (FPGA). In some embodiments, such the integrated circuit executes instructions stored on the circuit itself. In addition, some embodiments execute the software stored in a programmable logic device (PLD), ROM, or RAM device.

Although the present invention is described by way of examples and preferred embodiments, it should be understood that the invention is not limited to the disclosed embodiments. Rather, the present invention is intended to cover a variety of modifications and similar arrangements (as will be apparent to those skilled in the art). Accordingly, the scope of the additional claims should be given the broadest possible interpretation to cover all such modifications and similar arrangements.

What is claimed is:

1. A method for processing partition backlighting of a projected image, wherein the method is executed by a projection device, the projection device projects an original image onto a projection screen to display the projected image, and the method comprises:
performing keystone correction on the original image to be projected to obtain corrected image data; and
correcting backlighting brightness of at least one of a plurality of backlighting partitions of the projection device, respectively based on the corrected image data after the keystone correction.

2. The method as claimed in claim 1, wherein the operation of correcting the backlighting brightness of at least one of a plurality of backlighting partitions of the projection device, respectively based on the corrected image data after the keystone correction comprises:
correcting the backlighting brightness of a backlighting partition at a corresponding position based on the corrected image data of at least one of the plurality of backlighting partitions in the same position.

3. The method as claimed in claim 2, wherein a position of the at least one backlighting partition is any one of overall backlighting regions of the projection device.

4. The method as claimed in claim 2, wherein the corrected image data has a plurality of image partitions, and the at least one of the plurality of backlighting partitions corresponds to at least one of the plurality of image partitions of the corrected image data.

5. The method as claimed in claim 4, wherein position coordinates of the at least one of the plurality of backlighting partitions are the same as position coordinates of the at least one of the plurality of image partitions of the corrected image data.

6. The method as claimed in claim 1, further comprising:
determining a junction partition where an edge of the projected image displayed on the projection screen is adjacent to a backlighting image; and
performing junction partition backlighting smoothing processing on a backlighting of the junction partition.

7. The method as claimed in claim 6, wherein the junction partition is determined based on a backlighting region adjacent to the edge of the corrected image data.

8. The method as claimed in claim 6, wherein the junction partition is determined based on a data position and backlighting partition information of the corrected image.

9. The method as claimed in claim 6, wherein the junction partition backlighting smoothing processing is a median filter processing.

10. The method as claimed in claim 1, further comprising:
determining an edge portion of the at least one of the plurality of backlighting partitions; and
performing a backlighting smoothing processing on the edge portion of the at least one backlighting partition.

11. The method as claimed in claim 10, wherein the backlighting smoothing processing is a low pass filter processing.

12. A projection device, comprising a processing unit, a backlighting module and a memory module, which is arranged to perform the method for processing partition backlighting of a projected image of claim 1.

13. The projection device as claimed in claim 12, wherein a program code stored by the memory module is executed by the processing unit to control the backlighting module to correct a backlighting brightness of at least one of a plurality of backlighting partitions of the projection device, respectively.
